(19) United States
(12) Patent Application Publication
(10) Pub. No.: US 2008/0243439 A1
(43) Pub. Date: Oct. 2, 2008

(54) Sensor exploration and management through adaptive sensing framework

(76) Inventors: Paul R. Runkle, Chapel Hill, NC (US); Tushar Tank, Raleigh, NC (US); Austin I.D. Eliazar, Morrisville, NC (US); Trampas Stern, Raleigh, NC (US); Lawrence Carin, Durham, NC (US)

Correspondence Address: SUGHRUE MION, PLLC, 2100 PENNSYLVANIA AVENUE, N.W., SUITE 800, WASHINGTON, DC, 20037, US

(21) Appl. No.: 11/727,668

(22) Filed: Mar. 28, 2007

(51) Int. Cl. G06F 19/00; G06F 17/40

(52) U.S. Cl. 702/188; 702/182; 702/187; 702/179

(57) ABSTRACT

The identification and tracking of objects from captured sensor data relies upon statistical modeling methods to sift through large data sets and identify items of interest to users of the system. Statistical modeling methods such as Hidden Markov Models in combination with particle analysis and Bayesian statistical analysis produce items of interest, identify them as objects, and present them to users of the system for identification feedback. The integration of a training component based upon the relative cost of sampling sensors for additional parameters, provides a system that can formulate and present policy decisions on what objects should be tracked, leading to an improvement in continuous data collection and tracking of identified objects within the sensor data set.

### TECHNICAL AREA

The present invention is directed toward novel means and methods for analyzing data captured from various sensor suites and systems. The sensor suites and systems used with the present invention may consist of video, audio, radar, infrared, or any other sensor suite for which data can be extracted, collected and presented to users.

### BACKGROUND OF THE INVENTION

The use of suites of sensors for collecting and disseminating data that provides warning or condition information is common in a variety of industries. Likewise, the use of automated analysis of collected information is a standard practice to reduce large amounts of complex data to a compact form is appropriate to inform a decision making process. Data mining is one form of this type of activity. However, systems that provide deeper analysis of collected data, provide insight as well as warnings, and that produce policies for later sensor action and user interaction are not common. Systems that provide quantitative risk assessment and active learning for analysts are equally rare. The instant invention is a novel and innovative means for analysis of collected sensor data that provides the deployed system with an advanced and accelerated response capability to produce insight from collected sensor data, with or without user intervention, and produce decision and policy suggestions for future action regardless of the sensor type.

The instant invention addresses the development and real-world expression of algorithms for adaptive processing of multi-sensor data, employing feedback to optimize the linkage between observed data and sensor control. The instant invention is a robust methodology for adaptively learning the statistics of canonical behavior via, for example, a Hidden Markov Model process, or other statistical modeling processes as deemed necessary. This method is then capable of detecting behavior not consistent with typically observed behavior. Once anomalous behavior has been detected, the instant invention, with or without user contribution, can formulate policies and decisions to achieve a physical action in the monitored area. These feature extraction methods and statistical analysis methods constitute the front-end of a Sensor Management Agent for anomalous behavior detection and response.

The instant invention is an active multi-sensor system with three primary sub-systems that together provide active event detection, tracking, and real-time control over system reaction and alerts to users of the system. The Sensor Management Agent (SMA), Tracking, and Activity Evaluation modules work together to receive collected sensor data, identify and monitor artifacts disclosed by the collected data, manage state information, and provide feedback into the system. The resultant output consists of both analytical data and policy decisions from the system for use by outside agents. The results and policy decision data output by the system may be used to inform and control numerous resultant applications such as Anomaly Detection, Tracking through Occlusions, Bayesian Detection of targets, Information Feature extraction and optimization, Video Tracking, Optimal Sensor Learning and Management, and other applications that may derive naturally as desirable uses for data collected and analyzed from the deployed sensor suite.

### BRIEF DESCRIPTION OF THE DRAWINGS

FIG. 1: system diagram for the Active Multi-Sensor System design.

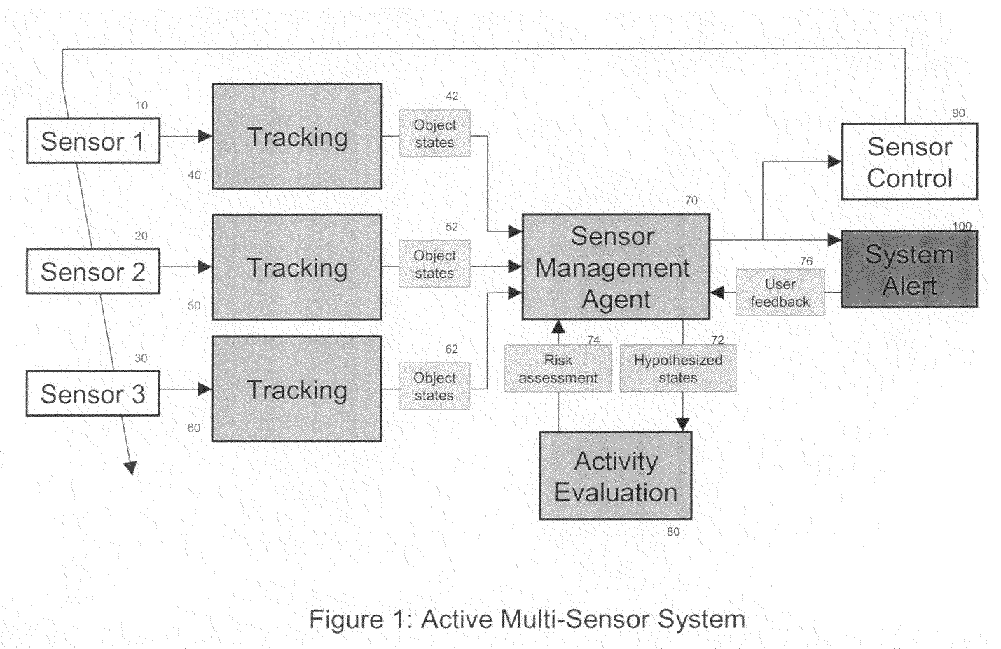

FIG. 2: detailed system diagram for the Tracking module of the Active Multi-Sensor System.

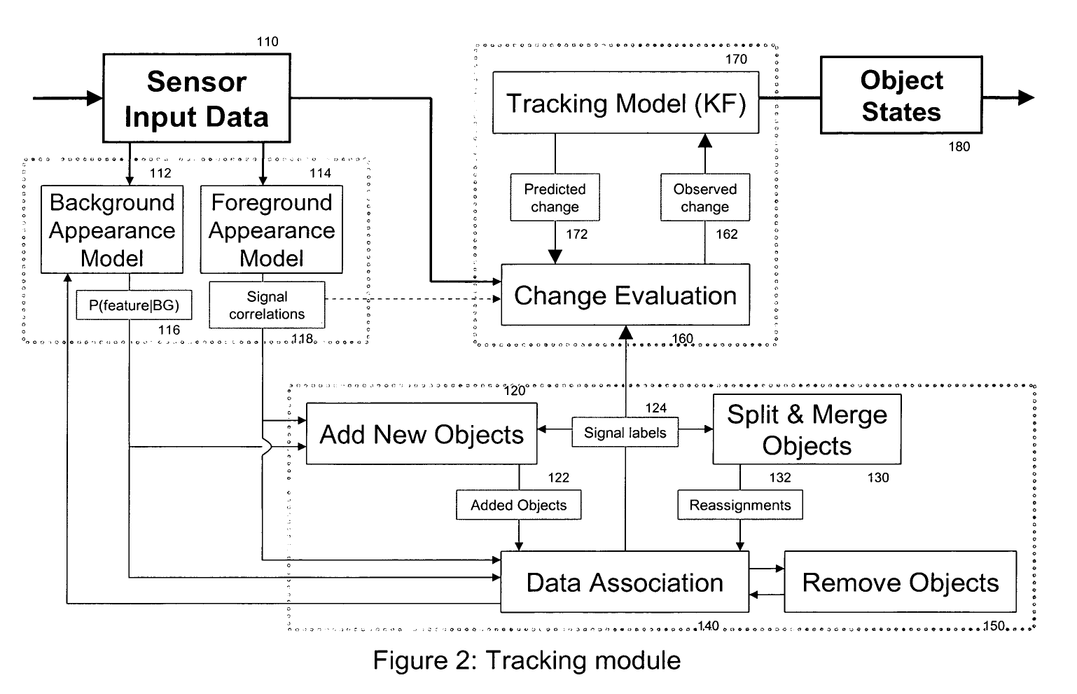

FIG. 3: detailed system diagram for the Sensor Management Agent of the Active Multi-Sensor System.

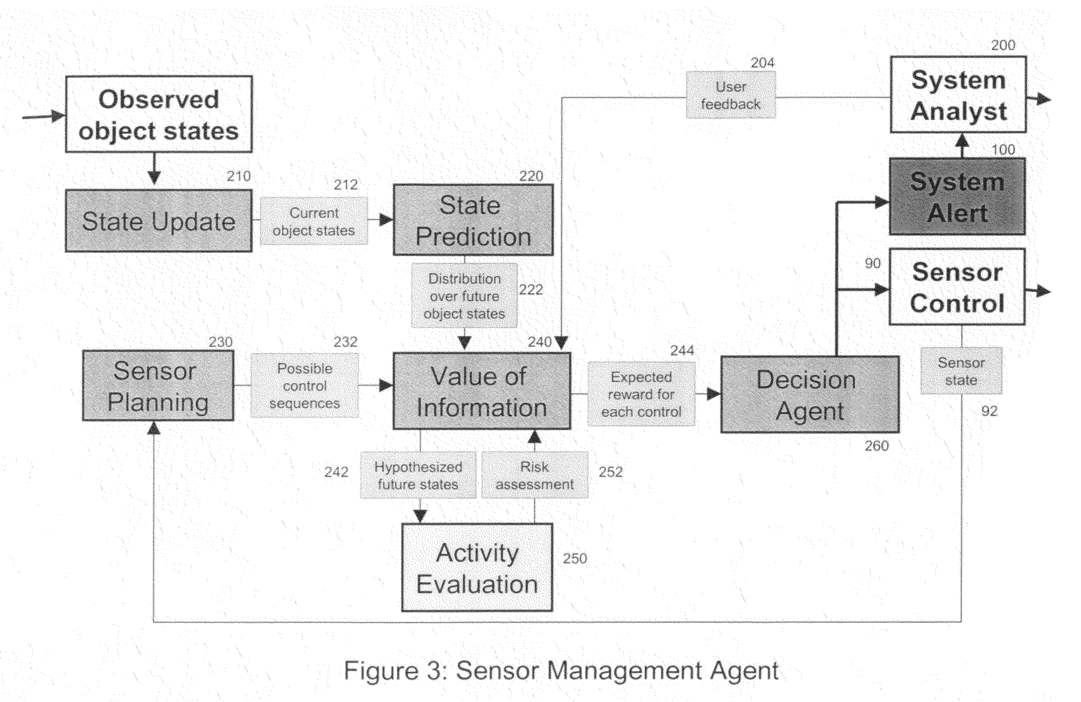

FIG. 4: detailed system diagram for the Activity Evaluation module of the Active Multi-Sensor System.

FIG. 5: Tracking Dynamic Objects centroid capture and synthesis.

FIG. 6: Variational Bayes Learning performance chart illustrating learning curve.

FIG. 7: Decision surface based upon collected sensor data.

### SUMMARY OF THE INVENTION

The instant invention is a novel and innovative system for the collection and analysis of data from a deployed suite of sensors. The system detects unusual events that may never have been observed previously. Therefore, rather then addressing the task of training an algorithm on events that we may never observe a priori, the system focuses on learning and modeling the characteristics of normal or typical behavior. This motivates development of graphical statistical models, such as hidden Markov models (HMMs), based on measured data characteristics of normal behavior. An atypical event will yield sequential features with a low likelihood of being consistent with such models, and this low likelihood will be used to alert personnel or deploy other sensors. The algorithmic techniques under consideration are based on state-of-the-art data models. The sensor-management algorithms that employ these models are optimal, for both finite and infinite sensing horizons, and are based on new partially observable Markov decision processes (POMDPs). POMDPs are used as they represent the forefront of adaptive sensor management. The integration of such advanced statistical models and sensor-management tools provides a feedback link between sensing and signal processing, yielding significant improvements in system performance. Improvements in system performance are measured as optimal classification performance for given sensing costs. The techniques being pursued are applicable to general sensor modalities, for example audio, video, radar, infrared and hyper-spectral.

In the preferred embodiment, the system is focused on developing methods to detect anomalous human behavior in collected video data. However, the invention is by no means limited to collected video data and may be used with any deployed sensor suite. The underlying sensor management system has three fundamental components: a Tracking module, which provides the identification of objects of interest and parametric representation (feature extraction) of such objects, an Activity Evaluation module, which provides the statistical characterization of dynamic features using general statistical modeling, and a Sensor Management Agent (SMA) module that optimally controls sensor actions based on the SMA's “world understanding” (belief state). This belief state is driven by the dynamic behavior of objects under interrogation wherein the objects to be interrogated are those items identified within the collected data as objects or artifacts of interest.

In the preferred embodiment, the Tracking module is an adaptive-sensing system that employs multiple sensors and multiple resolutions within a given modality (e.g., zoom capability in video). When performing sensing, the feature extraction process within the module is performed for multiple sensors and at multiple resolutions. The features also address time-varying data, and therefore they may be sequential. Feature extraction uses multiple methods for video background subtraction, object identification, parametric object representation, and object tracking via particle filters to identify and catalog objects for future examination and tracking.

After the Tracking module has performed multi-sensor, multi-resolution feature extraction, the Activity Evaluation module uses generative statistical models to characterize different types of typical/normal behavior. Data observed subsequently is deemed anomalous if it has a low likelihood of being generated by such models. Since the data are generally time varying (sequential), hidden Markov models (HMMs) have been employed in the preferred embodiment, however, other statistical modeling methods may also be used. The statistical modeling method is used to drive the policy-design algorithms employed for sensor management. In the preferred embodiment, HMMs are used to model video data to train the system regarding multiple human behavior classes.

A partially observable Markov decision process (POMDP) algorithm is one statistical modeling method that will utilize the aforementioned HMMs to yield an optimal policy for adaptive execution of sensing actions. The optimal policy includes selection from among the multiple sensors and sensor resolutions, while accounting for sensor costs. The policy also determines when to optimally stop sensing and make classification decisions, based upon user provided costs to compute the Bayes risk. In addition, the POMDP may take the action of asking an analyst to examine and label new data that may not necessarily appear anomalous, but for which access to the label would improve algorithm performance. In the preferred embodiment this defines which of several hierarchal classes is most appropriate for newly observed data. This type of activity is typically called active learning. In this context, the underlying statistical models are adaptively refined and updated as the characteristics of the scene represented by the captured data change, with the sensing policy refined accordingly. The sensor management framework does not rely on the statistical modeling method used, but is also possible with a model-free reinforcement-learning (RL) setting, building upon collected sensor data. The POMDP and RL algorithms have significant potential in solving general multi-sensor scheduling and management problems.

The Activity Evaluation module of the inventive system utilizes multiple sensor modalities as well as multiple resolutions within a single modality. For example, in the preferred embodiment this modality comprises captured video with zoom capabilities. The system adaptively performs coarse-to-fine sensing via the multiple modalities, to determine whether observed data are consistent with normal activities. In the preferred embodiment, the principal initial focus will be on video and acoustic sensors. However, the system will be modular, and the underlying algorithms are applicable to general sensors; therefore, the system will allow future integration of other sensor modalities. It is envisioned that the current system may be integrated with adaptive multi-sensor security data collected from a deployed integrated multi-sensor suite.

The Sensor Management Agent module is the central decision and policy dissemination module in the system. The Sensor Management Agent receives input from the Tracking module and the Event Detection module. The input from the Tracking module consists of sensor data that has been processed to produce sensor artifacts that are used as input to state update algorithms within the SMA. The SMA processes the sensor data as it is extracted by the Tracking module to create and refine predictions about future states. The SMA places a value on the state information that is partially composed of feedback evaluation information from a System Analyst, such as a Human agent, and partially composed of the automated evaluation of risk provided from the Activity Evaluation module. This information valuation is then processed to produce an optimal set of control decisions for the sensor, based on optimizing the detection of anomalous behavior.

The Activity Evaluation module processes the input data from the SMA using the statistical models and returns risk assessment information as input to the information value process of the SMA module. The SMA may take the action of asking an analyst to examine and label new data from the valuation process that may not necessarily appear anomalous, but for which access to the label would improve algorithm performance. In the instant invention, this action would be to define which of the hierarchal classes is most appropriate for newly observed data, with this action termed active learning. In the current embodiment, the underlying statistical models for video sequences are adaptively refined as the characteristics of the video scene under evaluation change, thereby providing updates to the sensing policy to respond to a continually changing environment.

In the preferred embodiment, the final product from the proposed system is a modular video-acoustic system, integrated with a full hardware sensor suite and employing state-of-the-art POMDP adaptive-sensing algorithms. The system will consist of an integrated suite of portable and reconfigurable sensors, deployable in and adaptive to general environments. However, the preferred embodiment only reflects one possible outcome from one possible sensor suite. It should be readily apparent to one of ordinary skill in the art that the instant invention is not constrained to one type of sensor and that input data may be received from any sensor suite for analysis and results reporting to users of the system described herein.

### DETAILED DESCRIPTION OF THE INVENTION

The instant invention was created to address the real-world need for predictive analysis in systems that determine policies for alerts and action so as to manage or prevent anomalous actions or activities. The predictive nature of the instant invention is built around the capture of data from any of a plurality of sensor suites (10-30) coupled with an analysis of the captured data using statistical modeling tools. The system also employs a relational learning method 160, system feedback (either automated or human directed) 76, and a cost comprised of a weighting of risk associated with the likelihood of any predicted action 74. Once anomalous behavior has been detected, the instant invention, with or without a user contribution 76, can formulate policies and direct actions in a monitored area 260.

The preferred embodiment presented in this disclosure uses a suite of audio and video sensors (10-30) to capture and analyze audio/visual imagery. However, this in no way limits the instant invention to just this set of sensors or captured data. The invention may be used with any type of sensor or any suite of deployed sensors with equal facility.

Captured input data is routed from the sensors (10-30) to a series of tacking software modules (40-60) which are operative to incorporate incoming data into a series of object states (42-62). The Sensor Management Agent (SMA) 70 uses the input object states (42-62) data to produce an estimate of change for the state data. These hypothesized states 72 data are presented as input to the Activity Evaluation module 80. The Activity Evaluation module produces a risk assessment 74 evaluation for each input object state and provides this information to the SMA 70. The SMA determines whether the risk assessment 74 data exceeds an information threshold and issues system alerts 100 based upon the result. The SMA also provides next measurement operational information to the sensors (10-30) through the Sensor Control module 90. The system is also operative to provide User feedback 76 as an additional input to the SMA 70.

In the preferred embodiment, several feature-extraction techniques have been considered, and the statistical variability of such has been analyzed using hidden Markov models (HMMs) as the statistical modeling method of choice. Other statistical modeling methods may be used with equal facility. The inventors chose HMMs for their familiarity with the modeling method involved. In addition, entropic information-theoretic metrics have been employed to quantify the variability in the associated underlying data.

In the preferred embodiment, challenge for anomalous event detection in video data is to first separate foreground object activity 114 from the background scene 112. The inventers investigated using an inter-frame difference approach that yields high intensity pixel values in the vicinity of dynamic object motion. While the inter-frame difference is computationally efficient, it is ineffective at highlighting objects that are temporarily at rest and is highly sensitive to natural background motion not related to activity of interest such as tree and leaf motion. The inventive system currently employs a statistical background model using principal components analysis (PCA), with the background eigen-image corresponding to the principal image component with the largest eigenvalue. The PCA is performed on data acquired at regular intervals (e.g. every five minutes) such that environmental conditions (e.g. angle of illumination) are adaptively incorporated into the background model 112. Objects within a scene that are not part of the PCA background can easily be computed via projection onto the orthogonal subspace. An alternate embodiment of the inventive system may use nonlinear object ID and tracking methods.

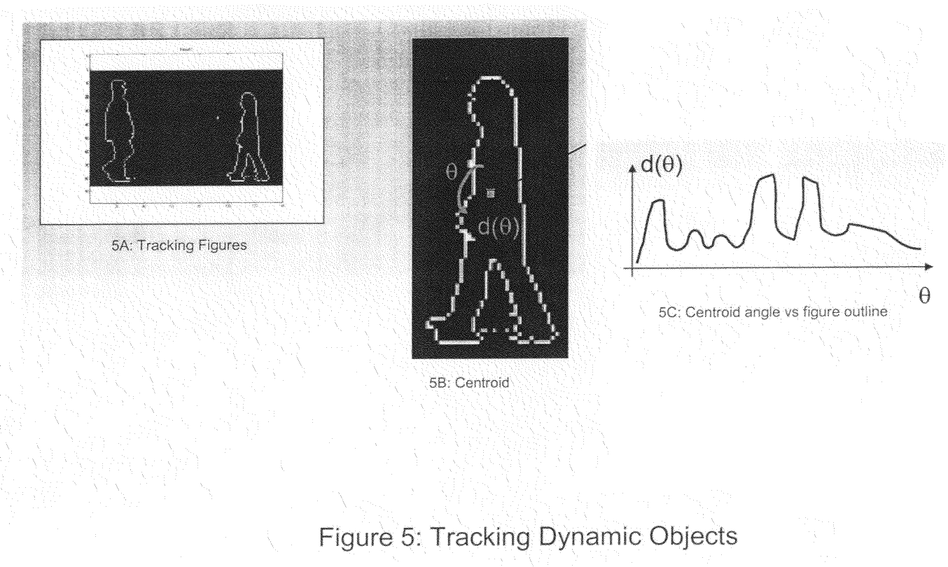

The objects within a scene are characterized via a feature-based representation of each object. The preferred embodiment uses a parametric representation of the distance between the object centroid and the external object boundary as a function of angle (FIG. 5). One of the strengths of this approach to object feature representation is the invariance to object-camera distance and the flexibility to describe multiple types of objects (people, vehicles, people on horses, etc.). This process produces a model of dynamic feature behavior that may be used to detect features and maintain an informational flow about said features that provide continuous mapping of artifacts and features identified by the system. This map results in a functional description of a dynamic object, which, in the preferred embodiment, may then be used as in input to a statistical modeling algorithm.

An objective in the preferred embodiment is to track level-set-derived target silhouettes through occlusions, caused by moving objects going through one another in the video. A particle filter is used to estimate the conditional probability distribution of the contour of the objects at time τ, conditioned on observations up to time τ. The video/data evolution time τ should be contrasted with the time-evolution t of the level-sets, the later yielding the target silhouette (FIG. 5).

The idea is to represent the posterior density function by a set of random samples with associated weights, and to compute estimates based on these samples and weights. Particle filtering approximates the density function as a finite set of samples. The inventers first review basic concepts from the theory of particle filtering, including the general prediction-update framework that it is based on, and then we describe the algorithm used for tracking objects during occlusions.

Let X_{τ} ε [symbol] ″ be a state vector at time τ evolving according to the following difference equation

X_{τ+1}=ƒ_{τ}(X_{τ})+u_{τ} (1)

where u_{τ} is i.i.d. random noise with known probability distribution function p_{u,τ}. Here the state vector describes the time-evolving data. At discrete times the observation Y_{τ} ε [symbol] ^{p} is available and our objective is to provide a density function for X_{τ}. The measurements are related to the state vector via the observation equation

Y_{τ}=h_{τ}(X_{τ})+v_{τ} (2)

where v_{τ} is measurement noise with known probability density function P_{v,τ} and h_{τ} is the observation function.

The silhouette resulting from the level-sets analysis is used as the state, and the image at time τ as the observation, i. e. Y_{τ}=I_{τ}(x,y). It is assumed that the system knows the initial state distribution denoted by p(X₀)=p₀(dx), the state transition probability p(X_{τ}|X_{τ-1}) and the observation likelihood given the state, denoted by g_{τ}(Y_{τ}|X_{τ}). The particle filter algorithm used in the preferred embodiment is based on a general prediction-update framework which consists of the following two steps:
Prediction step: Using the Chapman-Kolmogoroff equation, compute the prior state X_{τ}, without knowledge of the measurement at time τ, Y_{τ}

p(X_{τ}|Y_{0:τ-1})=∫p(X_{τ}|X_{τ-1})p(X_{τ-1}|Y_{0:τ-1})dx_{τ-1} (3)
Update step: Compute the posterior probability density function p(X_{τ|Y}_{0:τ}) from the predicted prior p(X_{τ|Y}_{0:τ-1}) and the new measurement at time τ, Y_{τ}

$$p \text{(} {X}_{τ} \vert {Y}_{0 : τ} ) = \frac{p ( {Y}_{τ} \vert {X}_{τ} ) p ( {X}_{τ} \vert {Y}_{0 : τ - 1} )}{p ( {X}_{τ} \vert {Y}_{0 : τ - 1} )} \qquad ( 4 )$$

where

p(Y_{τ}|Y_{0:τ-1})=∫p(Y_{τ}|X_{τ})p(X_{τ}|Y_{0:τ-1})dx_{τ}. (5)

Since it is currently impractical to solve the integrals analytically, the system represents the posterior probabilities by a set of randomly chosen weighted samples (particles).

The particle filtering framework used in the preferred embodiment is a sequential Monte Carlo method which produces at each time τ, a cloud of N particles,

$${\{ {X}_{τ}^{( i )} \}}_{{N}_{i = 1}} .$$

This empirical measure closely “follows” p(X_{τ|Y}_{0:τ}), the posterior distribution of the state given past observations (denoted by p_{τ|τ}(dx) below).

The initial step of the algorithm is to sample N times from the initial state distribution p₀(dx), using the principle of importance sampling, to approximate it by

$${p}_{0}^{N} ( dx ) = \frac{1}{N} {\sum }_{i = 1}^{N} {δ}_{{X}_{0}^{( i )}} ( dx ) ,$$

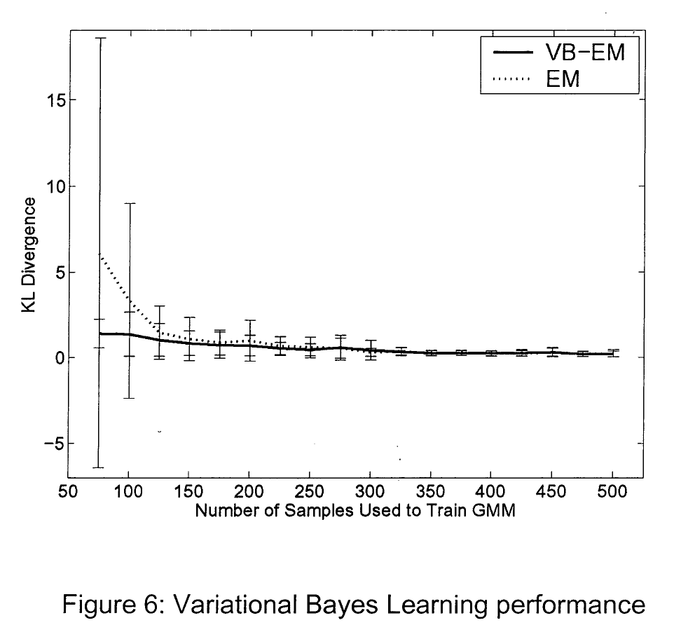

and then implement the Bayes' recursion at each time step (FIG. 6).
Now, the distribution of X_{τ-1} given observations up to time τ−1 can be approximated by

$${p}_{τ - 1 \vert τ - 1}^{N} ( dx ) = \frac{1}{N} {\sum }_{i = 1}^{N} {δ}_{{X}_{t - 1}^{( i )}} ( dx ) \qquad ( 6 )$$

The algorithm used for tracking objects during occlusions consists of a particle filtering framework that uses level-sets results for each update step.

This technique will allow the inventive system to track moving people during occlusions. In occlusion scenarios, using just the level sets algorithm would fail to detect the boundaries of the moving objects. Using particle filtering, we get an estimate of the state for the next moment in time p(X_{τ}|Y_{1:τ-1}), update the state

$$p \text{(} {X}_{τ} \vert {Y}_{1 : τ} ) \approx {\sum }_{i = 1}^{N} \frac{1}{N} {δ}_{{X}_{τ}^{( i )}} ( dx ) ,$$

and then use level sets for only a few iterations, to update the image contour γ(τ+1). With this algorithm, objects are tracked through occlusions and the system is capable of approximating the silhouette of the occluded objects.

The hidden Markov model (HMM) is a popular statistical tool for modeling a wide range of time series data. The HMM represents one special case of more-general graphical models and was chosen for use in the preferred embodiment for its ability to model time series data and the time-evolving properties of the object features.

Temporal object dynamics are represented via a HMM, with multiple HMMs developed to represent canonical “normal” object behavior. The underlying HMM states serve to capture the variety of object feature manifestations that may be observed for normal behavior. For example, as a person walks, the object features typically exhibit a periodicity that can be captured by an appropriate HMM state-transition architecture. In the preferred embodiment, the object features are represented using a discrete HMM with a regularization term to mitigate association of anomalous features to the discrete feature codebook developed while training the system 320. Variational Bayes methods are used to determine the proper number of HMM states 220. Such methods may also be applied to determining the optimal number of codebook elements for each state, or the optimal number of mixture components if a continuous Gaussian mixture model representation (GMM) is utilized.

The instant invention defines the “state” of a moving target by its orientation with respect to the sensor (e.g., video camera). For example, in the preferred embodiment a car or individual may have three principal states, defined by the view of the target from the sensor: (i) front view, (ii) back view and (iii) side view. This is a general concept, and the number of appropriate states will be determined from the data, using Bayesian model selection.

In general the sensor has access to the data for a given target, while the explicit state of the target with respect to the sensor is typically unknown, or “hidden”. The target generally will move in a predictable fashion, with for example a front view followed by a side view, with this followed by a rear view. However, there is some non-zero probability that this sequence may be altered slightly for a specific target. The instant invention has developed an underlying Markovian model for the sequential motion of the target. Specifically, the probability that the target will be in a given state at time index n is dictated completely by the state in which the target resides at time index n-1. Since the underlying target motion is modeled via a Markov model in the preferred embodiment, and the underlying state sequence is “hidden”, this yields a hidden Markov model (HMM).

The HMM is defined by four principal quantities: (i) the set of states S; (ii) the probability of transitioning from state i to state j on consecutive observations, represented by p(sⱼ|sᵢ); (iii) the probability of being in state i for the initial observation, this represented by πᵢ; and (iv) the probability of observing data o in state s, represented as p(o|s). For a Partially Observed Markov Decision Policy (POMDP) this model is generalized to take into account the effects of the sensing action a, represented by p(o|s,a) and p(sⱼ|sᵢ, a).

There are standard algorithms for learning the model parameters if the number of states S is known a priori. For example, one may utilize the Baum-Welch or Viterbi algorithm for HMM parameter design. However, for the adaptive learning algorithms of the preferred embodiment, the number of states may not be known a priori, and this must be determined based on the data. For example, different types of targets (individuals, vehicles, small groups, etc.) may have different numbers of states, and this must be determined autonomously by the algorithm.

In the preferred embodiment the system employs the variational Bayes method, in which the prior p(θ|Hᵢ) is assumed separable in each of the parameters,

$$p \text{(} θ \vert {H}_{i} ) = {\prod }_{m = 1}^{M} p ( {θ}_{m} \vert {H}_{i} ) ,$$

and each of the p(θₘ|Hᵢ) is made conjugate to the corresponding component within the likelihood p(D|θ,Hᵢ). Because of the assumed conjugate priors, the posterior may also be approximated as a product of the same conjugate density functions, which we employ as a basis for the posterior. In particular, let

Q(θ;β)≈p(θ|D,Hᵢ) (9)

be a parametric approximation to the posterior, with the parameters β defined by the parameters of the corresponding conjugate basis functions. The variational functional F(β) is defined as

$$\begin{matrix}F ( β ) = \int d θ Q ( θ ; β ) ln \frac{Q ( θ ; β )}{p ( D \vert θ , {H}_{i} ) p ( θ \vert {H}_{i} )} \\ = {D}_{KL} [ Q ( θ ; β ‖ p ( θ \vert D , {H}_{i} ) ] - ln p ( D \vert {H}_{i} )\end{matrix} \qquad ( 10 )$$

By examining the right hand side of (10), we note that F(θ) is lower bounded by In p(D|Hᵢ), with the lower bound achieved with the Kullback-Leibler distance between the basis Q(θ;β) and the posterior p(θ|D,Hᵢ), D_{KL}[Q(θ;β)∥p(θ|D,Hᵢ)], is minimized. Given the conjugate form of the basis in (9), the integrals in (10) may often be computed analytically, for many graphical models, and specifically for the HMM. The variational Bayes algorithm consists of iteratively determining the basis-function parameters β that minimize (10), and the minimal F(β) so determined is an approximation to ln p(D|Hᵢ). This provides the log evidence for model Hᵢ, allowing the desired model comparison.

This therefore constitutes an autonomous sensor-management framework for adaptive multi-sensor sensing of a typical behavior in the Tracking module 170 of the instant invention.

The generative statistical models (HMMs) summarized above will be utilized in the preferred embodiment to provide sensor exploitation by an adaptive learning system module 240 within the Sensor Management Agent (SMA) 70. This is implemented by employing feedback between the observed data and sensor parameters (optimal adaptive sensor management) (FIG. 6). In particular, the preferred embodiment utilizes POMDP generative models of the type discussed above to constitute optimal policies for modifying sensor parameters based on observed data. Specifically, the POMDP is defined by a set of states, actions, observations and rewards (costs). Given a sequence of n actions and observations, respectively {a₁, a₂, . . . , aₙ} and {o₁, o₂, . . . , oₙ}, the statistical models yield a belief bₙ concerning the state of the environment under surveillance. The POMDP yields an optimal policy for mapping the belief state after n measurements into the optimal next action: bₙ→aₙ₊₁. This policy is based on a finite or infinite horizon of measurements and it accounts for the cost of implementing the measurements defined, for example, in units of time, as well as the Bayes risk associated with making decisions about the state of the environment (normal vs. anomalous behavior).

The POMDP framework is a mathematically rigorous means of addressing observed multi-sensor imagery (defining the observations o), different deployments of sensor parameters (defining the actions a), as well as the costs of sensing and of making decision errors. While learning of the policy is computationally challenging, this is a one-time “off-line” computation, and the execution of the learned policy may be implemented in real time (it is a look-up table that implements the mapping bₙ→aₙ₊₁). This framework provides a natural means of providing feedback between the observed data to the sensors, to optimize multi-sensor networks. The preferred embodiment will focus on multiple camera sensors. However, the general framework is applicable to any multi-sensor system that can employ feedback to optimize sensor management.

The partially observable Markov decision process (POMDP) represents the heart of the proposed algorithmic developments. The POMDP use in the preferred embodiment represents a significant new advancement for optimizing sensor managment.

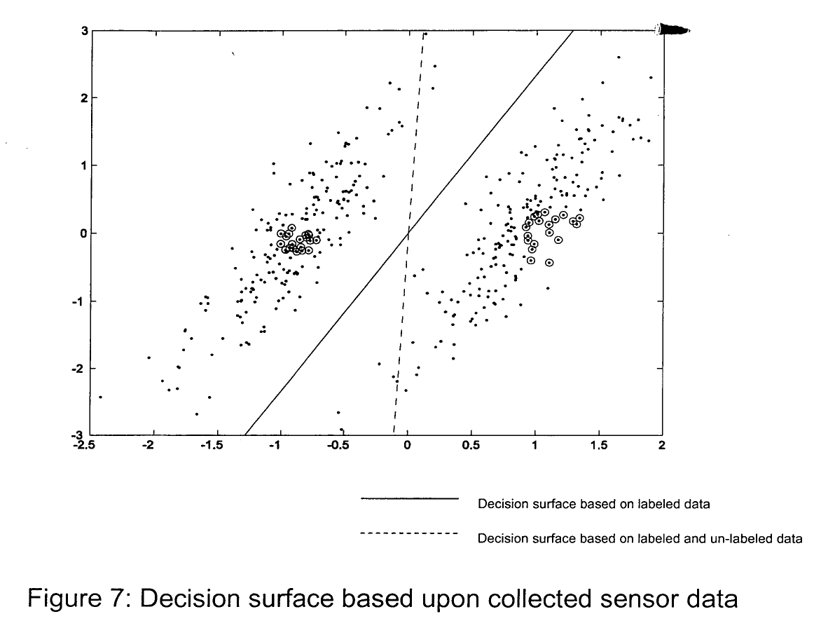

Partially observable Markov decision processes (POMDPs) are well suited to non-myopic sensing problems, which are those problems in which a policy is based on a finite or infinite horizon of measurements. It has been demonstrated previously that sensing a target from multiple target-sensor orientations may be modeled via a hidden Markov model (HMM). In the preferred embodiment, this concept may be extended to general sensor modalities and moving targets, as in video. Each state of the HMM corresponds to a contiguous set of target-sensor orientations for which the observed data are relatively stationary. When the sensor interrogates a given target (person/vehicle, or multiple people/vehicles) from a sequence of target-sensor orientations, it inherently samples different target states (FIG. 7). The instant invention extends the HMM formalism to a POMDP, yielding a natural and flexible adaptive-sensing framework for use within the Sensor Management Agent 70.

The POMDP is formulated in terms of Bayes risk, with Cᵤᵥ representing the cost of declaring target u when actually the target under interrogation is target v. Using the same units as associated with Cᵤᵥ, the instant invention also defines a cost for each class of sensing action. The use of Bayes risk allows a natural means of addressing the asymmetric threat, through asymmetry in the costs Cᵤᵥ. After a set of sensing actions and observations the sensor may utilize the belief state to quantify the probability that the target under interrogation corresponds to target u. The POMDP yields a non-myopic policy for the optimal sensor action given the belief state, where here the sensor actions correspond to defining the next sensor to deploy, as well as the associated sensor resolution (e.g., use of zoom in video). In addition, the POMDP gives a policy for when the belief state indicates that sufficient sensing has been undertaken on a given target to make a decision as to whether it is typical/atypical.

The instant invention computes the belief state and Bayes risk for data captured by the sensor suite. After performing a sequence of T actions and making T observations, we may compute the belief state for any state s ε S={sₖ⁽ⁿ⁾, ∀ k,n} as

b_{T}(s|o₁, . . . ,o_{T},a₁, . . . ,a_{T})=Pr(s|o_{T},a_{T},b_{T-1}) (11)

where (11) reflects that the belief state b_{T-1} is a sufficient statistic for {a₁, . . . , a_{T-1},o₁, . . . , O_{T-1}} . Note that the belief state is defined across the states from all targets, and it may be computed via

$$\begin{matrix}{b}_{T} ( {s}^{′} ) = \frac{Pr ( {o}_{T} \vert {s}^{′} , {a}_{T} , {b}_{T - 1} ) Pr ( {s}^{′} \vert {a}_{T} , {b}_{T - 1} )}{Pr ( {o}_{T} \vert {a}_{T} , {b}_{T - 1} )} \\ = \frac{Pr ( {o}_{T} \vert {s}^{′} , {a}_{T} , {b}_{T - 1} ) {\sum }_{s} Pr ( {s}^{′} \vert {a}_{T} , {b}_{T - 1} , s ) Pr ( s \vert {a}_{T} , {b}_{T - 1} )}{Pr ( {o}_{T} \vert {a}_{T} , {b}_{T - 1} )} \\ = \frac{p ( {o}_{T} \vert {s}^{′} , {a}_{T} ) {\sum }_{s} p ( {s}^{′} \vert {a}_{T} , s ) {b}_{T - 1} ( s )}{Pr ( {o}_{T} \vert {a}_{T} , {b}_{T - 1} )}\end{matrix} \qquad ( 12 )$$

The denominator Pr(o_{T}|a,b_{T-1}) may be viewed as a normalization constant, independent of s′, allowing b_{T}(s′) to sum to one.

After T actions and observations we may use (12) to compute the probability that a given state, across all N targets, is being observed. The belief state in (12) may also be used to compute the probability that target class n is being interrogated, with the result

$$p \text{(} n \vert {o}_{1} , … , {o}_{T} , {a}_{1} , … , {a}_{T} ) = p \text{(} n \vert {b}_{T} ) = {\sum }_{s ∈ {S}_{n}} {b}_{T} ( s ) \qquad ( 13 )$$

where Sₙ denotes the set of states associated with target n.

The SMA defines Cᵤᵥ to denote the cost of declaring the object under interrogation to be target u, when in reality it is target v, where u and v are members of the set { 1, 2, . . . , N}, defining the N targets of interest. After T actions and observations, target classification may be effected by minimizing the Bayes risk, i.e., we declare the target

$$Target = {arg min}_{u} {\sum }_{v = 1}^{N} {C}_{uv} p \text{(} v \vert {b}_{T} ) = {arg min}_{u} {\sum }_{v = 1}^{N} {C}_{uv} {\sum }_{s ∈ {S}_{v}} {b}_{T} ( s ) \qquad ( 14 )$$

Therefore, a classification may be performed at any point in the sensing process using the belief state b_{T}(s).

The instant invention also calculates a cost associated with deploying sensors and collecting data from said sensors. The sensing actions are defined by the cost of deploying the associated sensor. With regard to the terminal classification action, there are N² terminal states that may be visited. Terminal state sᵤᵥ is defined by taking the action of declaring that the object under interrogation is target u when in reality it is target v; the cost of state sᵤᵥ is Cᵤᵥ, as defined in the context of the Bayes risk previously calculated. The sensing costs and Bayes-risk costs must be in the same units. Making the above discussion quantitative, c(s,a) represents the immediate cost of performing action a when in state s. For the sensing actions indicated above c(s,a) is independent of the target state being interrogated (independent of s) and is only dependent on the type of sensing action taken. For the terminal classification action, defined by taking the action of declaring target u, we have

c(s,a=u)=Cᵤᵥ, ∀ s ε S, (15)

The expected immediate cost of taking action a in belief state b(s) is

$$C ( b , a ) = {\sum }_{s} b ( s ) c ( s , a ) \qquad ( 16 )$$

For sensing actions, that have a cost independent to s, the expected cost is simply the known cost of performing the measurement. For the terminal classification action the expected cost is

$$C ( b , a = u ) = {\sum }_{v = 1}^{N} {\sum }_{s ∈ {S}_{v}} b ( s ) {C}_{uv} = {\sum }_{v = 1}^{N} {C}_{uv} p ( v \vert b ) \qquad ( 17 )$$

and therefore the optimal terminal action for a given belief state b is to choose that target u that minimizes the Bayes risk. The SMA provides an evaluation for policies that define when a belief state b warrants taking such a terminal classification action. When classification is not warranted, the desired policy defines what sensing actions should be executed for the associated belief state b.

The goal of a policy is to minimize the discounted infinite-horizon cost

$$χ ( b ) = {min}_{a} \text{[} C ( b , a ) + γ {\sum }_{{b}^{′} ∈ B} p ( {b}^{′} \vert b , a ) χ ( {b}^{′} ) ] \qquad ( 18 )$$

where γ ε [0,1] is a discount factor that quantifies the degree to which future costs are discounted with respect to immediate costs, and B defines the set of all possible belief states. When optimized exactly for a finite number of iterations, the cost function is piece-wise linear and concave in the belief space.

After t consecutive iterations of (18) we have

$${χ}_{t} ( b ) = {min}_{a} \text{[} C ( b , a ) + γ {\sum }_{{b}^{′} ∈ B} p ( {b}^{′} \vert b , a ) {χ}_{t - 1} ( {b}^{′} ) ] \qquad ( 19 )$$

where χₜ(b) represents the cost of taking the optimal action for belief state b at t steps from the horizon. One may show that χₜ(b)=min_{αεC}_{ₜ} Σ_{sεS}α(s)b(s), where the α vectors come from a set Cₜ={α₁,α₂, . . . , αᵣ}, where in general r is not known a priori and is a function of t. Each α vector defines an |S|-dimensional hyperplane, and each is associated with an action, defining the best immediate policy assuming optimal behavior for the following t-1 steps. The cost at iteration t may be computed by “backing up” one step from the solution t-1 steps from the horizon. Recalling that

$${χ}_{t - 1} ( b ) = {min}_{α ∈ {C}_{t - 1}} {\sum }_{s ∈ S} α ( s ) b ( s ) ,$$

we have

$${χ}_{t} ( b ) = {min}_{a ∈ A} \text{[} C ( b , a ) + γ {\sum }_{o ∈ O} {min}_{α ∈ {C}_{t - 1}} {\sum }_{s ∈ S} {\sum }_{{s}^{′} ∈ S} p ( {s}^{′} \vert s , a ) p ( o \vert {s}^{′} , a ) α ( {s}^{′} ) b ( s ) ] \qquad ( 20 )$$

where A represents the set of possible actions (both for sensing and making classifications), and O represents the set of possible observations. When presenting results, the set of actions is discretized, as are the observations, such that both constitute a finite set.

The iterative solution of (20) corresponds to sequential updating of the set of α vectors, via a sequence of backup steps away from the horizon. In the preferred embodiment the SMA uses the state-of-the-art point-based value iteration (PBVI) algorithm, which has demonstrated excellent policy design on complex benchmark problems.

The sensing process is a sequence of questions asked by the sensor of the unknown target, with the physics providing the question answers. Specifically, the sensor asks: “For this unknown target, what would the data look like if the following measurement was performed?” To obtain the answer to this question the sensor performs the associated measurement. The sensor recognizes that the ultimate objective is to perform classification, and that a cost is assigned to each question. The objective is to ask the fewest number of sensing questions, with the goal of minimizing the ultimate cost of the classification decision (accounting for the costs of inaccurate classifications).

A reset formulation gives the sensor more flexibility in optimally asking questions and performing classifications within a cost budget. Specifically, the sensor may discern that a given classification problem is very “hard”. For example, prior to sensing it may be known that the object under test is one of N targets, and after a sequence of measurements the sensor may have winnowed this down to two possible targets. However, discerning between these final two targets may be a significant challenge, requiring many sensing actions. Once the complexity of the “problem” is understood, the optimal thing to do within this formulation is to stop asking questions and give the best classification answer possible, moving on to the next (randomly selected) classification problem, with the hope that it is “easier”. While the sensor may not do as well in classifying the “hard” classification problems, overall this action by the inventive system may reduce costs.

By contrast, if the sensor transitions into an absorbing state after performing classification, it cannot “opt out” of a “hard” sensing problem, with the hope of being given an “easier” problem subsequently. Therefore, with the absorbing-state formulation the sensor will on average perform more sensing actions, with the goal of reducing costs on the ultimate classification task.

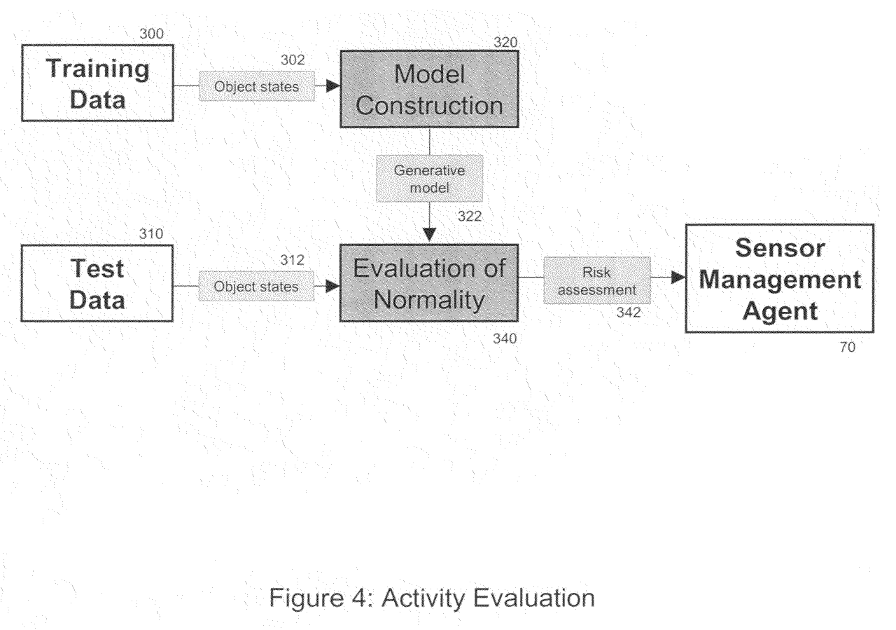

The most significant challenge in the inventive system is developing a policy that allows the ISR system to recognize that it is observing atypical behavior. This challenge is met by the Activity Evaluation module (FIG. 4). The Activity Evaluation module (FIG. 4) observes and recognizes atypical behavior to determine whether the scene under test corresponds to target T_{none,} where Tₙₒₙₑ represents that the data are representative of none of the typical target classes observed previously, in order to compare captured data against baseline data.

In the preferred embodiment, the system designates N graphical target models, for N hierarchical classes learned based on observing typical behavior. The algorithm may, after a sequence of measurements, take the action to declare the target under test as being any one of the N targets. In addition, the system may introduce a “none-of-the-above” target class, Tₙₒₙₑ, and allow the sensor-management agent to take the action of declaring Tₙₒₙₑ for the observed data. By utilizing the costs Cᵤᵥ, employed with Bayes risk, the inventive system can severely penalize errors in classifying data within the N classes. In this manner the SMA 70 will develop a policy that recognizes that it is preferable to declare Tₙₒₙₑ vis-à-vis making a forced decision to one of the N targets, when it is not certain.

Another function of the SMA 70 is to incorporate information from a human analyst in the loop of the policy decision process to provide reinforcement learning (RL) to the system. The framework outlined above consists of a two-step process: (i) data are observed and clustered, followed by graphical-model design for the hierarchical clusters; (ii) followed by policy design as implemented by (9) and (10). Once the policy is designed, a given sensing action is defined by a mapping from the belief state b to the associated action a. In this formulation the belief state is a sufficient statistic, and after N sensing actions retaining b determines the optimal N+1 action, rather than the entire history of actions and observations {a₁, a₂, . . . , a_{N},o₁, o₂, . . . ,o_{N}}.

The disadvantage of this approach is the need to learn the graphical models. Reinforcement learning (RL) is a model-free policy-design framework. Rather than computing a belief state, in the absence of a model, RL defines a policy that maps a sequence of actions and observations {a₁, a₂, . . . , a_{N},o₁, o₂, . . . , o_{N}} to an associated optimal action. During the policy-learning phase, the algorithm assumes access to a sequence of actions, observations, and associated immediate rewards: {a₁, a₂, . . . , a_{N}, o₁, o₂, . . . , o_{N}, r₁, r₂, r_{N}}, where rₙ is the immediate reward for action and observation aₙ and oₙ. The algorithm again learns a non-myopic policy that maps {a₁, a₂, . . . , a_{N}, o₁, o₂, . . . , o_{N}} to an associated action a_{N+1}, but this is performed by utilizing the immediate rewards rₙ observed during the training phase. Reinforcement learning is a mature technology for Markov decision processes (MDPs), but it is not fully developed for POMDPs. The SMA 70 develops and uses an RL framework, and compares its utility to model-based POMDP design to produce the optimum algorithm for policy-learning. In the policy-learning phase the immediate rewards rₙ are defined by the cost of the associated actions aₙ and on whether the target under test is typical or atypical 340. The integration of the analyst within multi-sensor policy design is manifested most naturally within the RL framework.

The instant invention has developed effective methods for dynamic object ID and tracking in the context of controlled video scenes within the preferred embodiment. The inventive system has also demonstrated tracking and feature extraction for initial video datasets of complex outdoor scenery with moving vehicles, foliage, and clouds and in the presence of occlusions under rigorous test conditions.

In the preferred embodiment, the system has successfully applied object ID, tracking and feature analysis to non-overlapping training and testing data. To produce initial results, the system utilized data with multiple individuals exhibiting multiple types of behavior, but within the context of the same background scene. This training methodology is consistent with the envisioned SMA 70 concept, where each sensor will learn and adapt to various types of behavior typical to the scene that it is interrogating. For each object that is being tracked, the system extracts multiple feature sets corresponding to the temporal video sequence of that object while it is in view of the camera. FIG. 6 illustrates the pseudo-periodic nature of the feature sequence for a walking subject. The solid line near the top of the graph is indicative of “energy” associated with the subject's head, while the oscillations near the bottom of the graph indicate leg motion.

While feature analysis of existing video data has been performed in Matlab, the inventers are confident that real-time conversion of single objects within a frame to discrete HMM codebook elements is easily accomplished on current-generation DSP development boards. This is not surprising since after performing the PCA analysis in the training phase, the projection of the extracted features onto the PCA dictionary is simply a linear operation, which can be implemented very efficiently even in conventional hardware.

The preferred embodiment also applies the precepts for the system to the use of HMMs in extracting feature sequences from captured video data. Subsequent to feature extraction, PCA analysis and projection of the features onto their appropriate VQ codes, the system trained HMMs according to three different behavior types: walking, falling, and bending. Since the features for each of these behavior types are well-behaved and exhibit consistent clustering in the PCA feature subspace, the system uses a relatively small discrete HMM codebook size of eight vectors, one of which represented a “null code”. Features not representative of behavior observed in the training process were mapped into this null code, which exhibited the smallest, but non-zero likelihood of being observed within any particular HMM state. There was significant statistical separation between normal and anomalous behavior for over one thousand video sequences under test, thereby successfully demonstrating proof-of-concept for detection of this behavior.

The inventive system to be deployed is a portable, modular, reconfigurable and adaptive multi-sensor system for addressing any asymmetric threat. The inventive system will initially develop and test all algorithms in Matlab and will subsequently perform DSP system-level testing via Simulink. The first-generation prototypes will exist on DSP development boards, with a Texas Instrument floating-point DSP chip family similar to that used in commercially avaiable systems. The preferred embodiment will require some additional video development into which the inventive system will integrate real-time DSP algorithms.

However, the inventive system is not limited to captured audio and video data and can allow integration of other sensors of potential interest to many industry segments including, but not limited to, radar, IP, and hyperspectral sensor suites. The inventive system is portable, modular, and reconfigurable in the field. These features allow the inventive system to be deployed in the field, provide a development path for future integration of new sensor modalities, and provide for the repositioning and integration of a sensor suite to meet particular missions for clients in the field.

The system will initially collect data of typical/normal behavior for the scene under test, and the data will then be clustered via the hierarchical clustering algorithm within the Tracking module 170 of the inventive system. This process employs feature extraction and graphical models embedded within the system database. Finally, these models will be employed to build POMDP and RL policies for optimal multi-sensor control, for the particular configuration in use.

The inventive system is also adaptive to new environments and conditions via the POMDP and RL algorithms within the SMA 70, yielding a policy for the optimal multi-sensor action for the data captured. The optimal policy will be non-myopic, accounting for sensing costs and the Bayes risk associated with making classification decisions.

In addition to expanding the number of sensors that may be deployed in the preferred embodiment which uses captured audio and video sensor data, some of the new components are the adaptive signal processing and sensor-management algorithms for more general sensor configurations. Specifically, by employing adaptive sensor control, the system may operate over significantly longer periods with the current storage capabilities, since the sensor will adaptively collect multi-sensor data at a resolution commensurate with the scene under interrogation (vis-à-vis having to preset the system resolution, as done currently). In addition, rather than fixing the manner in which the sensors collect data, the proposed system will perform multi-sensor adaptive data collections, with the adaptivity controlled via the POMDP/RL policy.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A system for collecting data from a deployed sensor network and providing predictive analysis for use in system operations comprising:
at least two sensors located in geospatially separate areas;
a communications means for transporting collected data from said sensors to a system server;
a memory storage unit within said server on which are stored software modules for tracking, activity evaluation, sensor management agent, sensor control, and issuing system alerts to users;
said software modules using statistical modeling means for predictive state management based upon a plurality of parameters to produce a probabilistic evaluation for an occurrence of event change in the modeled sensor data;
using said predicted probabilistic evaluation data to preferentially select portions of said collected sensor data for continued evaluation;
without human input, identify previously unknown events or objects within said collected sensor data and provide said information to a decision agent software process;
said software modules accepting feedback from said users to update a learning database for defining said preferentially selected sensor data within said system server;
issuing sensor control signals from said sensor management agent software module to said sensors located in geospatially separate areas to request additional sensor data collection, or to modify parameters for sensor data collection;
without human supervision, comparing said preferentially selected portions of collected sensor data to a predefined set of events and causing said decision agent process to issue said system alert to users when any of said predefined events is detected and a pre-set risk threshold is exceeded.

2. A system as shown in claim 1 for collecting data from a deployed sensor network and providing predictive analysis for use in system operations further comprising:
said sensors may be sensors that collect video, audio, radar, infrared, ultrasonic, or hyper-spectral data, or any combination of said sensor types.

3. A system as shown in claim 1 for collecting data from a deployed sensor network and providing predictive analysis for use in system operations further comprising:
Said tracking software module receives sensor input data from deployed sensor devices;
Said tracking software module is active to modify a sensor input data base;
Said tracking software transforms sensor input data into object data and stores said object data into an object and object state data base;
Said tracking software module operates upon received sensor data to reconcile data changes between predicted object change and observed object change in said received sensor data and update said sensor input data base;
Said tracking software module utilizes said data changes to produce state data for objects defined in said sensor input data;
Said tracking software module outputs said object state data to said sensor management agent software module.

4. A system as shown in claim 1 for collecting data from a deployed sensor network and providing predictive analysis for use in system operations further comprising:
Said sensor management agent software module accepts object state data from said tracking software module;
Said sensor management agent software module establishes an information value for each object state based upon a cost for acquiring new observed data for said object state, user feedback, state update data, state prediction data, and a risk assessment value as input from said activity evaluation software module;
Said sensor management agent software module statistical modeling algorithms to calculate an expected relative valuation for each object and sensor measurement action and provides this data to said decision agent process;
Said sensor management agent software module, without human intervention, develops a policy for decisions regarding escalation of object state data for further action by the system and outputs sensor control and system alert information to sensors and users of the system.

5. A system as shown in claim 1 for collecting data from a deployed sensor network and providing predictive analysis for use in system operations further comprising:
Said activity evaluation software module accepts evaluated object state data from said sensor management agent and training feedback data from a system user;
Said activity evaluation software module utilizes training feedback data to actively identify new objects and update the object model data base stored within said server;
Said activity evaluation software module evaluates object state data through the use of a Bayesian modeling means to identify a level of risk that each identified object is a normal object for the given data model and outputs said risk assessment to said sensor management agent software module.

6. A system as shown in claim 1 for collecting data from a deployed sensor network and providing predictive analysis for use in system operations further comprising:
Said statistical modeling means utilizes Hidden Markov Model statistical modeling.

7. A system as shown in claim 1 for collecting data from a deployed sensor network and providing predictive analysis for use in system operations further comprising:
Said statistical modeling means utilizes principal components analysis.

8. A system as shown in claim 1 for collecting data from a deployed sensor network and providing predictive analysis for use in system operations further comprising:
Said statistical modeling means utilizes nonlinear object ID tracking.

9. A system as shown in claim 3 for collecting data from a deployed sensor network and providing predictive analysis for use in system operations further comprising:
Said stored object data is created using a parametric representation of the distance between the object centroid and the external object boundary as a function of angle;

10. A system as shown in claim 3 for collecting data from a deployed sensor network and providing predictive analysis for use in system operations further comprising:
Said stored object state data is created using a particle filtering framework algorithm that uses level-sets analysis for each update step.

11. A system as shown in claim 3 for collecting data from a deployed sensor network and providing predictive analysis for use in system operations further comprising:
Said predicted object change data is created by a partially observed Markov decision policy (POMDP) algorithm;

12. A system as shown in claim 11 for collecting data from a deployed sensor network and providing predictive analysis for use in system operations further comprising:
Means for said POMDP statistical model algorithm to use inputs of collected sensor state, action, observation, and cost data to produce said object change data.

13. A system as shown in claim 1 for collecting data from a deployed sensor network and providing predictive analysis for use in system operations further comprising:
Means for utilizing a POMDP algorithm to identify previously unknown events or objects within said collected sensor data without prior identification;
Providing said previously unknown event and object data as input to said decision agent module.

14. A system as shown in claim 4 for collecting data from a deployed sensor network and providing predictive analysis for use in system operations further comprising:
Wherein said cost is associated with deploying sensors and collecting data from said sensors;
And wherein said cost further comprises a fixed cost for performing a sensor measurement and a predicted cost for the difficulty of requesting said sensor measurement.

15. A system as shown in claim 4 for collecting data from a deployed sensor network and providing predictive analysis for use in system operations further comprising:
Wherein said sensor management agent updates object state information;
Said sensor management agent utilizes sensor planning data in combination with said updated object state information to create prediction data for the value of said object state data to be collected by the next collection measurement action.

16. A system as shown in claim 4 for collecting data from a deployed sensor network and providing predictive analysis for use in system operations further comprising:
Wherein said policy decisions are those decisions that cause sensor measurement activities to be initiated.

17. A system as shown in claim 5 for collecting data from a deployed sensor network and providing predictive analysis for use in system operations further comprising:
Wherein said training feedback data is provided by interaction with a user of the system to initialize object and object state data base tables;
And wherein said training feedback data is requested by the system on a periodic bases only, after initialization of said object and object state data base tables.

18. A method for collecting data from a deployed sensor network and providing predictive analysis for use in system operations comprising:
deploying at least two sensors located in geospatially separate areas;
means for transporting collected data from said sensors to a system server;
storing data into a memory storage unit within said server including software modules for tracking, activity evaluation, sensor management agent, sensor control, and issuing system alerts to users;
said software modules using statistical modeling means for predictive state management based upon a plurality of parameters to produce a probabilistic evaluation for an occurrence of event change in the modeled sensor data;
using said predicted probabilistic evaluation data to preferentially select portions of said collected sensor data for continued evaluation;
without human input, identifying previously unknown events or objects within said collected sensor data and provide said information to a decision agent software process;
said software modules accepting feedback from said users to update a learning database for defining said preferentially selected sensor data within said system server;
issuing sensor control signals from said sensor management agent software module to said sensors located in geospatially separate areas to request additional sensor data collection, or to modify parameters for sensor data collection;
without human supervision, comparing said preferentially selected portions of collected sensor data to a predefined set of events and causing said decision agent process to issue said system alert to users when any of said predefined events is detected and a pre-set risk threshold is exceeded.

19. A method as shown in claim 18 for collecting data from a deployed sensor network and providing predictive analysis for use in system operations further comprising:
deploying sensors that collect video, audio, radar, infrared, ultrasonic, or hyper-spectral data, or any combination of said sensor types.

20. A method as shown in claim 18 for collecting data from a deployed sensor network and providing predictive analysis for use in system operations further comprising:
Said tracking software module receiving sensor input data from deployed sensor devices;
Said tracking software module modifying a sensor input data base;
Said tracking software transforming sensor input data into object data and storing said object data into an object and object state data base;
Said tracking software module operating upon received sensor data to reconcile data changes between predicted object change and observed object change in said received sensor data and update said sensor input data base;
Said tracking software module utilizing said data changes to produce state data for objects defined in said sensor input data;
Said tracking software module transferring said object state data to said sensor management agent software module.

21. A method as shown in claim 18 for collecting data from a deployed sensor network and providing predictive analysis for use in system operations further comprising:
Said sensor management agent software module accepting object state data from said tracking software module;
Said sensor management agent software module establishing an information value for each object state based upon a cost for acquiring new observed data for said object state, user feedback, state update data, state prediction data, and a risk assessment value as input from said activity evaluation software module;
Said sensor management agent software module using statistical modeling algorithms to calculate an expected relative valuation for each object and sensor measurement action and provides this data to said decision agent process;
Said sensor management agent software module, without human intervention, developing a policy for decisions regarding escalation of object state data for further action by the system and relaying sensor control and system alert information to sensors and users of the system.

22. A method as shown in claim 18 for collecting data from a deployed sensor network and providing predictive analysis for use in system operations further comprising:
Said activity evaluation software module accepting evaluated object state data from said sensor management agent and training feedback data from a system user;
Said activity evaluation software module utilizing training feedback data to actively identify new objects and update the object model data base stored within said server;
Said activity evaluation software module evaluating object state data through the use of a Bayesian modeling means to identify a level of risk that each identified object is a normal object for the given data model and relaying said risk assessment to said sensor management agent software module.

23. A method as shown in claim 18 for collecting data from a deployed sensor network and providing predictive analysis for use in system operations further comprising:
Said statistical modeling means utilizing Hidden Markov Model statistical modeling.

24. A method as shown in claim 18 for collecting data from a deployed sensor network and providing predictive analysis for use in system operations further comprising:
Said statistical modeling means utilizing principal components analysis.

25. A method as shown in claim 18 for collecting data from a deployed sensor network and providing predictive analysis for use in system operations further comprising:
Said statistical modeling means utilizing nonlinear object ID tracking.

26. A method as shown in claim 20 for collecting data from a deployed sensor network and providing predictive analysis for use in system operations further comprising:
creating said stored object data using a parametric representation of the distance between the object centroid and the external object boundary as a function of angle;

27. A method as shown in claim 20 for collecting data from a deployed sensor network and providing predictive analysis for use in system operations further comprising:
creating said stored object state data using a particle filtering framework algorithm that uses level-sets analysis for each update step.

28. A method as shown in claim 20 for collecting data from a deployed sensor network and providing predictive analysis for use in system operations further comprising:
creating said predicted object change data by a partially observed Markov decision policy (POMDP) algorithm;

29. A method as shown in claim 28 for collecting data from a deployed sensor network and providing predictive analysis for use in system operations further comprising:
Means for initializing said POMDP statistical model algorithm using inputs of collected sensor state, action, observation, and cost data to produce said object change data.

30. A method as shown in claim 18 for collecting data from a deployed sensor network and providing predictive analysis for use in system operations further comprising:
Means for utilizing a POMDP algorithm to identify previously unknown events or objects within said collected sensor data without prior identification;
Providing said previously unknown event and object data as input to said decision agent module.

31. A method as shown in claim 21 for collecting data from a deployed sensor network and providing predictive analysis for use in system operations further comprising:
Wherein said cost is associated with deploying sensors and collecting data from said sensors;
And wherein said cost further comprises a fixed cost for performing a sensor measurement and a predicted cost for the difficulty of requesting said sensor measurement.

32. A method as shown in claim 21 for collecting data from a deployed sensor network and providing predictive analysis for use in system operations further comprising:
Wherein said sensor management agent updates object state information;
Said sensor management agent utilizing sensor planning data in combination with said updated object state information to create prediction data for the value of said object state data to be collected by the next collection measurement action.

33. A method as shown in claim 21 for collecting data from a deployed sensor network and providing predictive analysis for use in system operations further comprising:
Wherein said policy decisions are those decisions causing sensor measurement activities to be initiated.

34. A method as shown in claim 22 for collecting data from a deployed sensor network and providing predictive analysis for use in system operations further comprising:
Wherein said training feedback data is provided by interacting with a user of the system to initialize object and object state data base tables;
And wherein said training feedback data is requested by the system on a periodic bases only, after initialization of said object and object state data base tables.
